(19) United States
(12) Patent Application Publication
(10) Pub. No.: US 2022/0318522 A1
(43) Pub. Date: Oct. 6, 2022

(54) USER-CENTRIC AND EVENT SENSITIVE PREDICTIVE TEXT SUMMARY

(71) Applicant: INTERNATIONAL BUSINESS MACHINES CORPORATION, Armonk, NY (US)

(72) Inventors: Christine T. Wolf, Newman, CA (US); Jeanette Blomberg, Portola Valley, CA (US); Pravar Mahajan, Sunnyvale, CA (US); Shubhi Asthana, Santa Clara, CA (US); Aly Megahed, San Jose, CA (US); Pei Guo, Mercer Island, WA (US); Shikhar Kwatra, San Jose, CA (US)

(21) Appl. No.: 17/221,917

(22) Filed: Apr. 5, 2021

(51) Int. Cl. G06F 40/40; G06N 3/08; G06N 3/04; G06F 40/279; G06F 40/30; G06F 40/166

(52) U.S. Cl. CPC G06F 40/40; G06N 3/08; G06N 3/0445; G06F 40/279; G06F 40/30; G06F 40/166

(57) ABSTRACT

Systems and methods for generating user-centric and event-sensitive text summaries are described. For example, summaries may be generated based on user selected reading parameters and user workflow. According to some embodiments, a reinforcement learning module is used to modify a change summarization network based on user feedback. For example, a text summary may change in real-time based on changes to the reader or event context. In some cases, user actions and feedback (e.g., a number of edits to a text summary or the editing time taken by a user) are used to improve prediction of future summaries.

### BACKGROUND

The following relates generally to document summarization, and more specifically to text summarization.

Natural language processing (NLP) is a field of computer science relating to speech and/or text interactions between computers and humans. For example, in NLP, a computer may be programmed to understand human language and respond accordingly. In some cases, the computer can understand the underlying nuances and context associated with natural language. This provides the ability for humans to communicate with a computers, and vise-versa.

Text summarization refers to the NLP task of producing concise summaries representative of a broader document or a set of documents. A text summary helps users understand the relevance of a document without needing to read an entire document, thus saving user time. In some cases, text summarization may include finding and extracting appropriate concepts in a document, ranking sentences (e.g., using statistical analysis), generating a summary, etc. In some cases, text summarization systems combine semantically related terms to provide meaningful sequences for summarizing a document. Additionally, a summary of a change to an underlying document may be useful for identifying iterative changes to a large body of text.

However, conventional text summarization systems do not incorporate reader parameters or an event context. Therefore, there is a need in the art for systems and methods to produce text summaries based on the needs of individual readers, and that provide summaries that take event into consideration.

### SUMMARY

The present disclosure describes systems and methods for generating user-centric and event-sensitive text summaries. For example, summaries may be generated based on user selected reading parameters and user workflow. According to some embodiments, a reinforcement learning module is used to modify a change summarization network based on user feedback. For example, a text summary may change in real-time based on changes to the reader or event context. In some cases, user actions and feedback (e.g., a number of edits to a text summary or the editing time taken by a user) are used to improve prediction of future summaries.

A method, apparatus, non-transitory computer readable medium, and system for text summarization are described. One or more embodiments of the method, apparatus, non-transitory computer readable medium, and system include generating a first summary of a corpus of information at a first time using a text summarization component, generating a second summary of the corpus of information at a second time using the text summarization component, wherein the corpus of information at the second time includes information related to an event, selecting one or more weights for a change summarization component, wherein the one or more weights are applied to an input of the change summarization network including user-specific reading parameters, and generating a change summary for the first summary and the second summary using the change summarization network.

An apparatus, system, and method for text summarization are described. One or more embodiments of the apparatus, system, and method include a text summarization component configured to generate a first summary of a corpus of information at a first time and a second summary of the corpus of information at a second time, wherein the corpus of information at the second time includes information related to an event, a change summarization component configured to generate a change summary for the first summary and the second summary based on the event, and a reinforcement learning model configured to update one or more weights of the text summarization component or the change summarization component.

A method, apparatus, non-transitory computer readable medium, and system for text summarization are described. One or more embodiments of the method, apparatus, non-transitory computer readable medium, and system include generating a first summary of a corpus of information at a first time using a text summarization component, generating a second summary of the corpus of information at a second time using the text summarization component, wherein the corpus of information at the second time includes information related to an event, selecting one or more weights for a change summarization component, wherein the weights are selected based at least in part on a reinforcement learning model, generating a change summary for the first summary and the second summary using the change summarization component, receiving user interaction data based on the change summary, and training the reinforcement learning model based on the user interaction data.

### BRIEF DESCRIPTION OF THE DRAWINGS

FIG. 1 shows an example of a text summarization system according to aspects of the present disclosure.

FIGS. 2 through 3 show examples of a process for text summarization according to aspects of the present disclosure.

FIG. 4 shows an example of a text summarization diagram according to aspects of the present disclosure.

FIG. 5 shows an example of a text summarization apparatus according to aspects of the present disclosure.

FIG. 6 shows an example of a change summarization diagram according to aspects of the present disclosure.

FIG. 7 shows an example of a process for reinforcement learning according to aspects of the present disclosure.

FIG. 8 shows an example of a reinforcement learning model diagram according to aspects of the present disclosure.

### DETAILED DESCRIPTION

The present disclosure describes systems and methods for generating user-centric and event-sensitive text summaries. For example, summaries may be generated based on user selected reading parameters and user workflow. According to some embodiments, a reinforcement learning module is used to modify a change summarization network based on user feedback. For example, a text summary may change in real-time based on changes to the reader or event context. In some cases, user actions and feedback (e.g., a number of edits to a text summary or the editing time taken by a user) are used to improve prediction of future summaries.

Machine learning based approaches may be used to customize text summaries based on user profile or user approaches to an event. In some cases, text summarization techniques may use unsupervised learning algorithms to generate a summary of events (e.g., by analysis of social media data) or use summarization models to select relevant sentences in a document. Since conventional techniques are not based on user job role or workflow, such customization of text summaries may not be appropriate for a user's role or workflow group, and may thus be less helpful for some users.

Embodiments of the present disclosure provide an improved change summarization network for customization of text summaries based on parameters such as a job role of a user, or the status of a workflow. A neural network (e.g., a recurrent neural network (RNN) such as a long short-term memory (LSTM) model) may provide variants of a text summary. In some examples, a learning module updates the change summarization network based on interactions from a user.

A text summary is a single short document that represents the synopsis of a longer document. In some cases, a text summary is generated to include content specifically intended for a user based on the user's profile (e.g., the user's job role within an organization) or the user's purpose (e.g., the information from the document desired by the user based on the user's workflow). For example, a different summary may be required for an overview than for a detailed read.

Accordingly, embodiments of the present disclosure provide text summaries and change summaries based on user-centricity and event-sensitivity. The user-centric approach implies the text summary is customized to a specific user role and the event-sensitivity is tailoring a text summary to a specific workflow-related event.

By applying the unconventional steps of implementing user-centricity and event-sensitivity via a change summarization network, embodiments of the present disclosure provide an improvement in customization of predictive text summaries. The change summarization network provides an initial text summarization, based on an input text and reading parameters, and also provides a summary of changes to the text based on user interaction and events. Advanced comparison techniques (based on natural language processing) are used to compute the deviation of content that provide variants of text summaries to a user. As a result, embodiments of the present disclosure provide for widespread potential applicability (e.g., consumer and retail use) by customizing text summarization on a user-specific basis, saving user time in having to re-read new documents or manually looking for changes in different versions of a document.

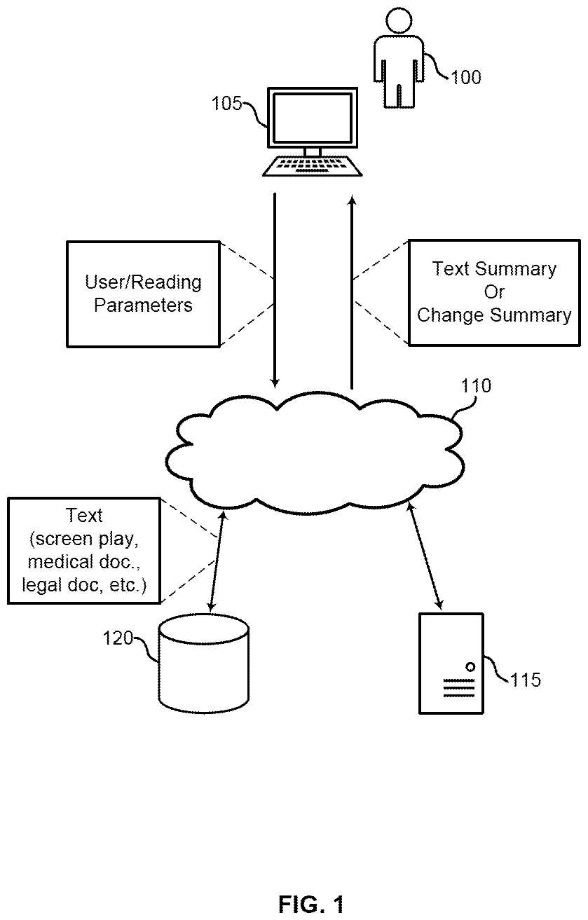

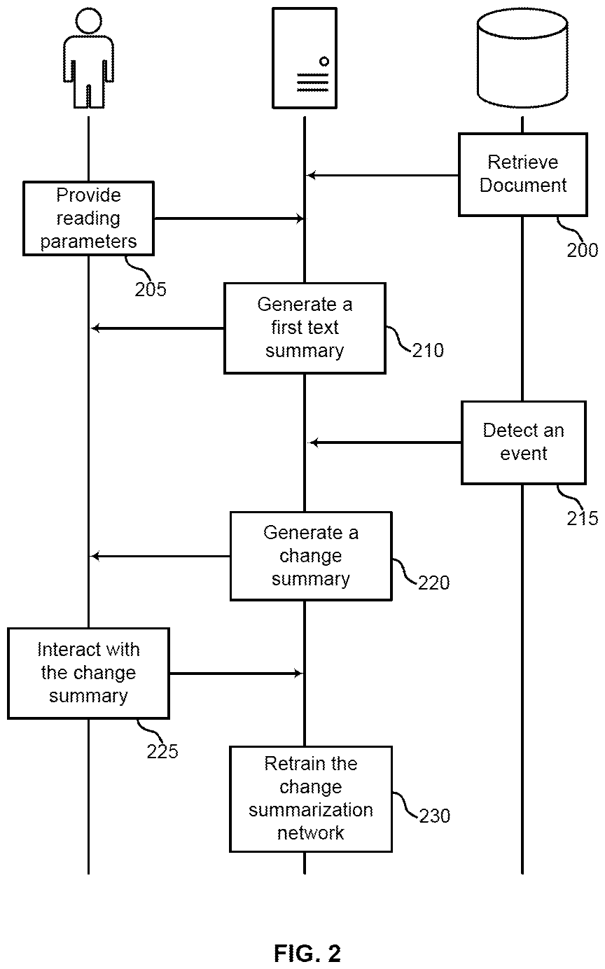

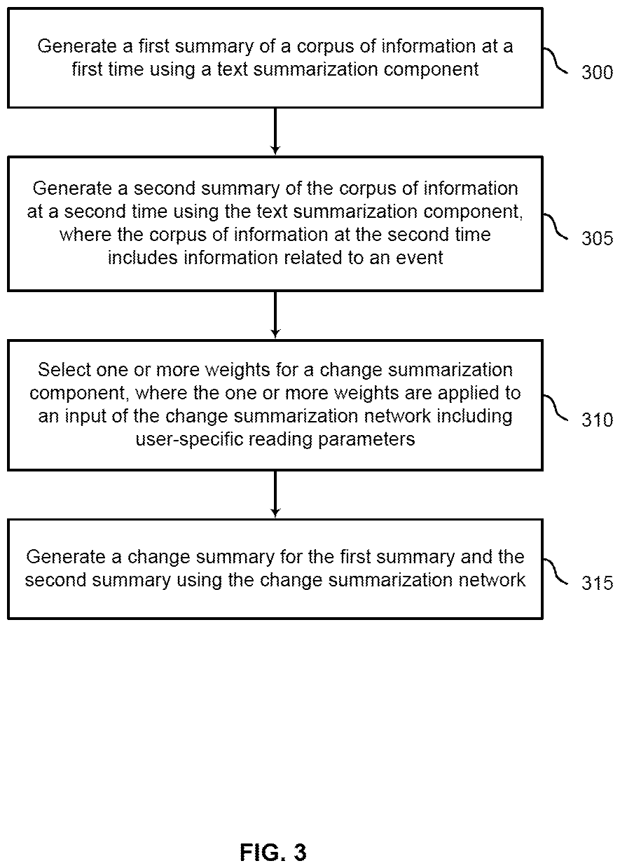

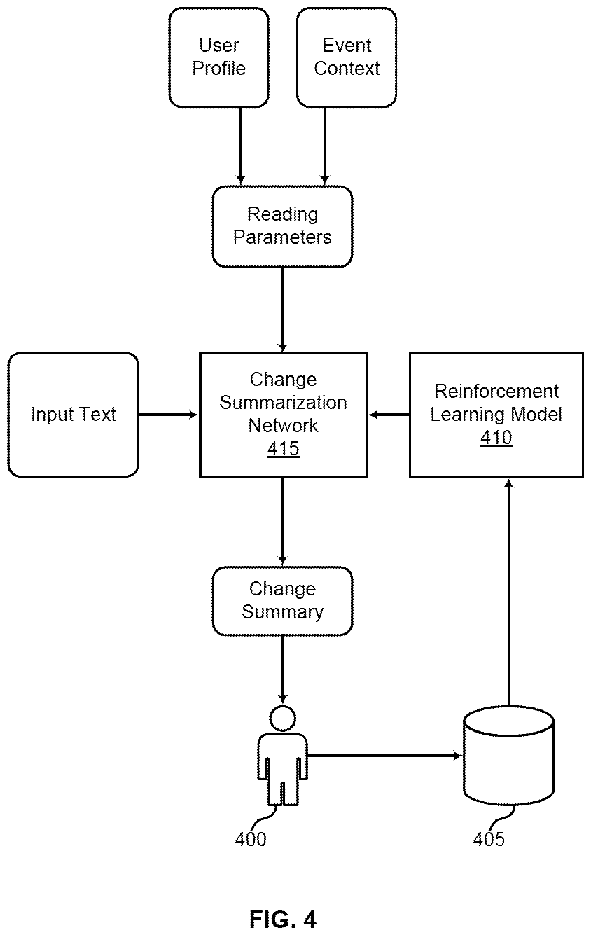

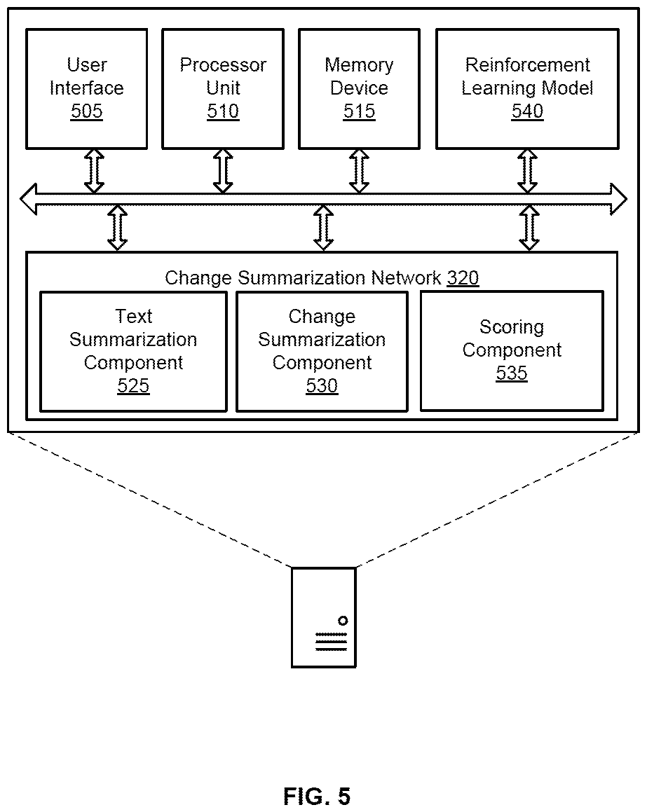

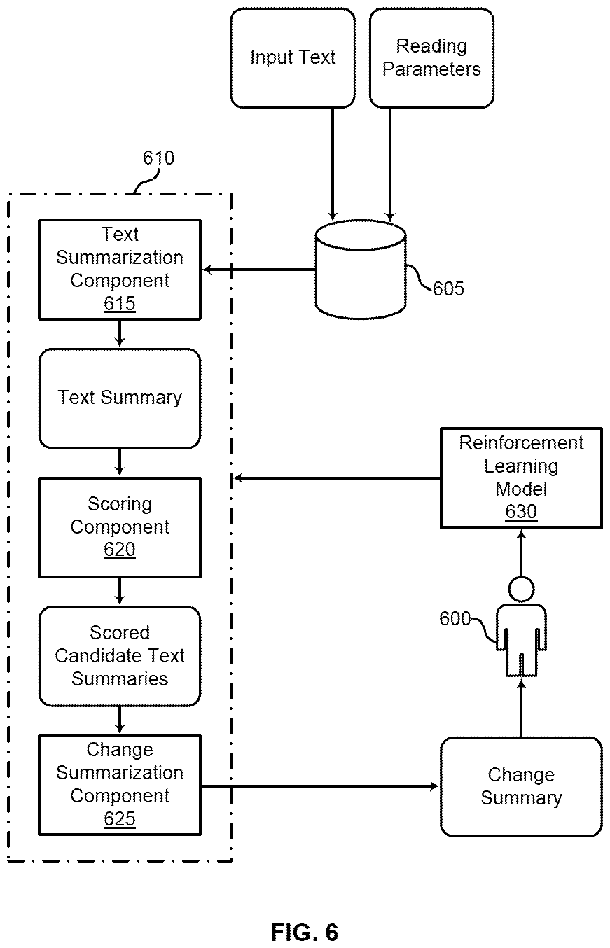

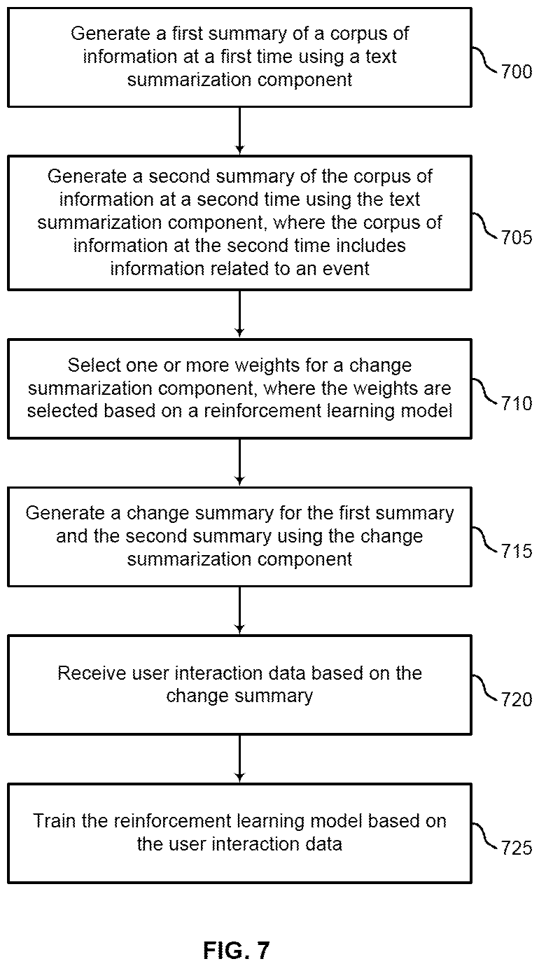

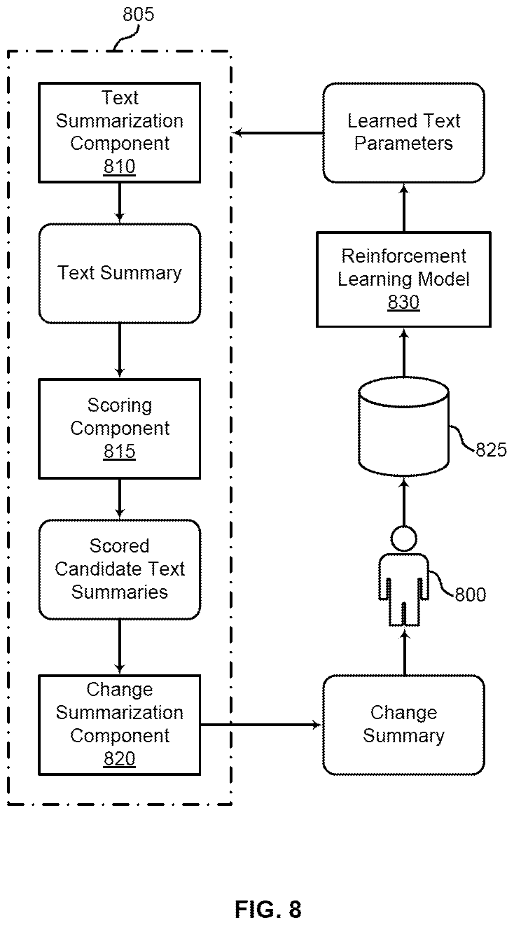

Embodiments of the present disclosure include a change summarization system that provides text summarization services based on interactions, changes, or events associated with an input document. An example a change summarization system is provided with reference to FIGS. 1 and 2. Details regarding the inference of the system is provided with references to FIGS. 3 and 4. A network architecture is provided with reference to FIGS. 5 and 6. An example training process is provided with reference to FIGS. 7 and 8.

### Change Summarization System

FIG. 1 shows an example of a text summarization system according to aspects of the present disclosure. The example shown includes user 100, device 105, cloud 110, text summarization apparatus 115, and database 120. User 100 is an example of, or includes aspects of, the corresponding element described with reference to FIGS. 4, 6, and 8.

The user 100 communicates with the text summarization apparatus 115 via the device 105 and the cloud 110. For example, the user 100 may provide reading parameters to the device 105, and the reading parameters may be used to define an output summarization. In some cases, the user may also provide input text. In other cases, the input text is stored in the database 120.

The text summarization apparatus 115 provides a summary of the input text to the user based on the reading parameters and an event context, such as changes to a workflow status or changes to the document being summarized. In some cases, the database 120 may detect a change to the input text, and the text summarization apparatus 115 can provide a change summarization based on the original text and the changed text. As in the example of FIG. 1, the input text may be a screen play, medical document, legal document, or any type of natural language document.

The device 105 may be a personal computer, laptop computer, mainframe computer, palmtop computer, personal assistant, mobile device, or any other suitable processing apparatus. The device 105 can include software that provides a text summarization service. For example, the device 105 may be a personal computer with a program to summarize input text based on user parameters.

A cloud 110 is a computer network configured to provide on-demand availability of computer system resources, such as data storage and computing power. In some examples, the cloud 110 provides resources without active management by the user 100. The term cloud 110 is sometimes used to describe data centers available to many users 100 over the Internet. Some large cloud 110 networks have functions distributed over multiple locations from central servers. A server is designated an edge server if it has a direct or close connection to a user 100. In some cases, a cloud 110 is limited to a single organization. In other examples, the cloud 110 is available to many organizations. In one example, a cloud 110 includes a multi-layer communications network comprising multiple edge routers and core routers. In another example, a cloud 110 is based on a local collection of switches in a single physical location.

The text summarization apparatus 115 may also include a processor unit, a memory unit, a user interface, and a training component. The training component is used to train the change summarization network. Additionally, the text summarization apparatus 115 can communicate with the database 120 via the cloud 110. Details regarding inferences of the text summarization apparatus 115 are provided with reference to FIGS. 3 and 4. Further detail regarding the architecture of the text summarization apparatus 115 is provided with reference to FIGS. 5 and 6. Further details regarding training of the text summarization apparatus 115 is provided with reference to FIGS. 7 and 8.

In some cases, the text summarization apparatus 115 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

In some embodiments, the text summarization apparatus 115 includes an artificial neural network to learn user interactions with the text summaries and/or the change summaries. An artificial neural network is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmit the processed signal to other connected nodes. In some cases, the signals between nodes comprise real numbers, and the output of each node is computed by a function of the sum of its inputs. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

The database 120 stores documents to be summarized. In some cases, the database can detect changes to the documents or updated versions of the documents. A database 120 is an organized collection of data. For example, a database 120 stores data in a specified format known as a schema. A database 120 may be structured as a single database, a distributed database, multiple distributed databases, or an emergency backup database. In some cases, a database controller may manage data storage and processing in a database 120. In some cases, a user 100 interacts with database controller. In other cases, database controller may operate automatically without user interaction. In some examples, the database 120 includes a set of media objects (e.g., image files). In some cases, a search is performed based on the sparse query embedding for the query object (e.g., a search image file), and at least one image file is retrieved from the database 120. In some other cases, no images are retrieved and returned to the user due to lack of similarity based on the sparse query embedding.

In some cases, a training component (e.g., a reinforcement learning module) may be used to train the text summarization apparatus 115 based on user interaction with a text summary and/or a change summary. User interactions are observed and stored in the database 120, and a feedback is provided back to the system to optimize the text summarization and change summarization processes.

FIG. 2 shows an example of a process for text summarization according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

The present disclosure provides event-sensitive text summaries of a document that are customized for users. Reading documents is a key part of many organizational workflows. For example, many strategic outsourcing deals in the global technology services (GTS) of an organization begin with extensive client documentation as requests for a proposal or solution such as a request for proposal or a request for service. Document-heavy workflows include legal field (e.g., document review in discovery), publishing industry (e.g., screening content for acquisition), and consumer contexts (e.g., reading books). When reading, users may get help from text summaries to understand highlights of a given text document. According to advanced text summarization approaches, one-time highlights of a universal summary are sufficient, but information requirements may differ depending on user roles (i.e., user-centric summary customization). User information requirements may change depending on event context (i.e., event-sensitive summary customization). The present disclosure provides a system and method for providing a user-centric, event-sensitive predictive text document summary. The present disclosure may provide a summary of changes in different versions of a document.

In some cases, text summarization techniques (i.e., summarization, lexical chain, and sentence ranking methods) are used to provide a predictive summary. The summarization method performs text summarization using topic modeling and concept mapping. The lexical chain provides text summarization by a linear time algorithm for calculating lexical chains that capture text connectiveness. The sentence ranking method is text summarization for a single document. Sentences, ranked by assigned weights, are extracted to produce a high-quality summary of an input document.

At operation 200, the database provides a document to the system. For example, the document may be a legal document, screen play, a patent document, or a financial document; but the present disclosure is not limited thereto. The document may contain natural language text in any language. The database may store multiple documents. In some cases, the operations of this step refer to, or may be performed by, a database as described with reference to FIG. 1.

At operation 205, the user provides reading parameters. The reading parameters may include a user profile or event context, which define the scope of the intended summarization. For example, the reading parameters may include information to summarize a document from a legal, medical, or engineering perspective. Additionally, the event context may relate to a sporting event, political rally, or the like. In some cases, the operations of this step refer to, or may be performed by, a user as described with reference to FIGS. 1, 6, and 8.

Embodiments of the present disclosure provide the ability for a user to manually select concepts from an ontology or indicate interest in a topic, which provides the reading parameters to the system. In some examples, there is no pre-programmed knowledge of the workflow-based role of a user or the effect of the role on text summarization. For example, a network architect who selects a word (e.g., Security) is given a different text summarization than a security architect who selects the same word or a lead storage manager.

In conventional text summarization systems, the relationship between users and a document is constant and does not change. Some text summarization methods may not be able to distinguish between the roles of users. As such, there is no tailoring of text summarization with a change in workflow-related event. User interests are fixed. For example, a lead storage manager (e.g., TSM) uses a different text summarization during the first read (i.e., high level overview or risk analysis) than a detailed final check read (i.e., granular level or punch-list). Furthermore, the text summaries are not customized based on a workflow-based event.

However, according to embodimetns of the present disclosure, the text summary depends on the user, the event context, or both. For example, a lead storage manager can use a different text summarization during the first read (i.e., high level overview or risk analysis) than a detailed final check read (i.e., granular level or punch-list).

At operation 210, the system generates a first text summary of the document. The first text summary contains a summarization of the input document, based on the reading parameters. In some cases, the operations of this step refer to, or may be performed by, a text summarization component as described with reference to FIGS. 5, 6, and 8.

At operation 215, the system detects an event. An event can be a change in the underlying document or any kind of user interaction with the document. In an example scenario, an event may be related to the progress in a workflow. In some cases, the operations of this step refer to, or may be performed by, a text summarization component as described with reference to FIGS. 5, 6, and 8.

At operation 220, the system generates a change summary. For example, after an event is detected, the system generates a summarization of the changes of the newest document compared to the previous document. In another example, relevant information changes based on a new stage of a workflow. In some cases, the operations of this step refer to, or may be performed by, a change summarization component as described with reference to FIGS. 5, 6, and 8.

At operation 225, the user may interact with the change summary. The user interaction with the change summary may include reading or editing the change summary, which provides a feedback of the user input for the training process. For example, a user may edit the change summary to edit specific verbiage. The system will return the edit information to the system to optimize the change summarization network. In some cases, the operations of this step refer to, or may be performed by, a user as described with reference to FIGS. 1, 6, and 8.

At operation 230, the system retrains the change summarization network based on the user interaction. In some cases, the operations of this step refer to, or may be performed by, a reinforcement learning model as described with reference to FIGS. 4-6, and 8.

### Change Summarization

A method, apparatus, non-transitory computer readable medium, and system for text summarization are described. One or more embodiments of the method, apparatus, non-transitory computer readable medium, and system include generating a first summary of a corpus of information at a first time using a text summarization component, generating a second summary of the corpus of information at a second time using the text summarization component, wherein the corpus of information at the second time includes information related to an event, selecting one or more weights for a change summarization component, wherein the one or more weights are applied to an input of the change summarization network including user-specific reading parameters, and generating a change summary for the first summary and the second summary using the change summarization network.

In some examples, the one or more weights are selected based on a reinforcement learning model. In some examples, the user-specific reading parameters are input to the change summarization component. In some examples, the user-specific reading parameters are input to the text summarizer. Some examples of the method, apparatus, non-transitory computer readable medium, and system described above further include identifying a role of a user, wherein the text summarization reading parameters are determined based on the role of the user.

Some examples of the method, apparatus, non-transitory computer readable medium, and system described above further include identifying one or more events including the event, wherein the one or more events are identified based on a role of the user. Some examples of the method, apparatus, non-transitory computer readable medium, and system described above further include generating a plurality of text summaries corresponding to the first time. Some examples further include scoring the plurality of text summaries. Some examples further include selecting the first text summary based on the scoring. Some examples of the method, apparatus, non-transitory computer readable medium, and system described above further include generating an explanation summary for the change summary.

In some examples, the explanation summary indicates portions of the change summary that are based on a role of the user, portions of the change summary that are based on user feedback, portions of the change summary that are based on events that occurred, or some combination thereof. In some examples, the change summarization component is customized for a specific user based on user feedback.

In some cases of personalized text summaries, a user profile is built based on a role of a user (i.e., not a workflow-related role). For example, the role of the user may be patent lawyer. The patent lawyer may want a summary that prioritizes independent claims above all else. As a result, the text summary may use a first claim above other sections of a patent document. The two approaches used for personalization are ontological concept-based user-centric and aspect-based personalized text summarization methods. The ontological concept-based approach uses manual selection of interests from the ontology by users. The selections are inputs to text summarization customization. In the aspect-based personalized approach, text summarization is personalized to a model which captures user interest in a topic. The model is based on self-reported user interest in a topic (i.e., 0-3 from no interest to high interest). For example, a study on displaying articles in relation to museum displays shows that a user has a high interest in marine biology and another user has a low interest in marine biology but high interest in popular culture.

FIG. 3 shows an example of a process for text summarization according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 300, the system generates a first summary of a corpus of information at a first time using a text summarization component. The first summary may include only a single input text document. In some cases, the operations of this step refer to, or may be performed by, a text summarization component as described with reference to FIGS. 5, 6, and 8.

At operation 305, the system generates a second summary of the corpus of information at a second time using the text summarization component, where the corpus of information at the second time includes information related to an event. The second summary may be the result of a change to the original input text document or a new input text document that supersedes the original input text document. In some cases, the operations of this step refer to, or may be performed by, a text summarization component as described with reference to FIGS. 5, 6, and 8.

At operation 310, the system selects one or more weights for a change summarization component, where the one or more weights are applied to an input of the change summarization network including user-specific reading parameters. In some cases, the operations of this step refer to, or may be performed by, a reinforcement learning model as described with reference to FIGS. 4-6, and 8.

At operation 315, the system generates a change summary for the first summary and the second summary using the change summarization network. In some cases, the operations of this step refer to, or may be performed by, a change summarization component as described with reference to FIGS. 5, 6, and 8.

FIG. 4 shows an example of a text summarization diagram according to aspects of the present disclosure. The example shown includes user 400, interaction database 405, and reinforcement learning model 410, and change summarization network 415.

In the example scenario presented in FIG. 4, a user profile and event context are provided to the change summarization network 415. Change summarization network 415 is an example of, or includes aspects of, the corresponding element described with reference to FIGS. 5, 6, and 8. Interaction database 405 is an example of, or includes aspects of, the corresponding element described with reference to FIG. 8.

According to some embodiments, reinforcement learning model 410 selects one or more weights for a change summarization component, where the one or more weights are applied to an input of the change summarization network 415 including user-specific reading parameters. In some examples, the one or more weights are selected based on a reinforcement learning model 410.

According to some embodiments, reinforcement learning model 410 is configured to update one or more weights of the text summarization component or the change summarization component. In some examples, the one or more weights are applied to an input layer of the change summarization component.

Reinforcement learning model 410 is an example of, or includes aspects of, the corresponding element described with reference to FIGS. 5, 6, and 8.

### Network Architecture

An apparatus, system, and method for text summarization are described. One or more embodiments of the apparatus, system, and method include a text summarization component configured to generate a first summary of a corpus of information at a first time and a second summary of the corpus of information at a second time, wherein the corpus of information at the second time includes information related to an event, a change summarization component configured to generate a change summary for the first summary and the second summary based on the event, and a reinforcement learning model configured to update one or more weights of the text summarization component or the change summarization component.

In some examples, the text summarization component comprises a sentence extraction model, a latent semantic analysis (LSA) model, or a Bayesian topic model. In some examples, the change summarization component comprises a recurrent neural network (RNN) or a transformer network.

Some examples of the apparatus, system, and method described above further include a user interface configured to display the change summary to a user and collect feedback from the user. In some examples, the one or more weights are applied to an input layer of the change summarization component.

FIG. 5 shows an example of a text summarization apparatus according to aspects of the present disclosure.

In one embodiment, text summary apparatus 500 includes user interface 505, processor unit 510, memory device 515, change summarization network 520, and reinforcement learning model 540.

According to some embodiments, user interface 505 is configured to display the change summary to a user and collect feedback from the user and receives user interaction data based on the change summary.

Change summarization network 520 is an example of, or includes aspects of, the corresponding element described with reference to FIGS. 4, 6, and 8. In one embodiment, change summarization network 520 includes text summarization component 525, change summarization component 530, and scoring component 535.

According to some embodiments, text summarization component 525 generates a first summary of a corpus of information at a first time using a text summarization component 525. In some examples, text summarization component 525 generates a second summary of the corpus of information at a second time using the text summarization component 525, where the corpus of information at the second time includes information related to an event. In some examples, the user-specific reading parameters are input to the text summarizer. In some examples, text summarization component 525 identifies a role of a user, where the text summarization reading parameters are determined based on the role of the user. In some examples, text summarization component 525 identifies one or more events including the event, where the one or more events are identified based on a role of the user. In some examples, text summarization component 525 generates a set of text summaries corresponding to the first time.

According to some embodiments, text summarization component 525 is configured to generate a first summary of a corpus of information at a first time and a second summary of the corpus of information at a second time, wherein the corpus of information at the second time includes information related to an event. In some examples, the text summarization component 525 includes a sentence extraction model, a latent semantic analysis (LSA) model, or a Bayesian topic model.

Sentence extraction is a method to summarize text automatically. Statistical heuristics are used to determine important sentences in a body of text, where the important sentences can be extracted. A Bayesian topic model applies semantic topics equal to latent distributions related to the distribution of words in a body of text. Therefore, a document can be modeled with various topics.

According to some embodiments, text summarization component 525 generates a first summary of a corpus of information at a first time using a text summarization component 525. In some examples, text summarization component 525 generates a second summary of the corpus of information at a second time using the text summarization component 525, where the corpus of information at the second time includes information related to an event. Text summarization component 525 is an example of, or includes aspects of, the corresponding element described with reference to FIGS. 6 and 8.

According to some embodiments, change summarization component 530 generates a change summary for the first summary and the second summary using the change summarization network 520. In some examples, the user-specific reading parameters are input to the change summarization component 530. In some examples, change summarization component 530 generates an explanation summary for the change summary. In some examples, the explanation summary indicates portions of the change summary that are based on a role of the user, portions of the change summary that are based on user feedback, portions of the change summary that are based on events that occurred, or some combination thereof. In some examples, the change summarization component 530 is customized for a specific user based on user feedback.

According to some embodiments, change summarization component 530 is configured to generate a change summary for the first summary and the second summary based on the event. In some examples, the change summarization component 530 includes a recurrent neural network (RNN) or a transformer network.

According to some embodiments, change summarization component 530 generates a change summary for the first summary and the second summary using the change summarization component 530. Change summarization component 530 is an example of, or includes aspects of, the corresponding element described with reference to FIGS. 6 and 8.

According to some embodiments, scoring component 535 scores the set of text summaries. In some examples, scoring component 535 selects the first text summary based on the scoring and scores the change summary based on the user interaction data. Scoring component 535 is an example of, or includes aspects of, the corresponding element described with reference to FIGS. 6 and 8. Reinforcement learning model 540 is an example of, or includes aspects of, the corresponding element described with reference to FIGS. 4, 6, and 8.

A processor unit 510 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

Examples of a memory device 515 include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

FIG. 6 shows an example of a change summarization diagram according to aspects of the present disclosure. The example shown includes user 600, summarization model database 605, change summarization network 610, and reinforcement learning model 630.

Change summarization network 610 is an example of, or includes aspects of, the corresponding element described with reference to FIGS. 4, 5, and 8. In one embodiment, change summarization network 610 includes text summarization component 615, scoring component 620, and change summarization component 625.

Text summarization component 615, scoring component 620, and change summarization component 625 are an example of, or includes aspects of, the corresponding element described with reference to FIGS. 5 and 8.

The event-centric customization of a text or change summary may be performed using two approaches (i.e., update summaries and event summaries). Update summaries model background knowledge of user by looking at prior documents and providing a summary that highlights new information in the current document. The approach is based on the user reading a document one time to gain an update on the domain topic. An update text summarization highlights the difference between a current document and prior documents. The event summaries approach analyzes social media data to identify and summarize social events (e.g., sporting events, concerts, or political rallies). The approach looks for temporal cues (i.e., spikes in activity) to identify key moments about an event and summarizes content created in relation to the cues.

Embodiments of the present disclosure provides a text summary of a given corpus for an event (Event N, Event N +1), and a summary of any changes to the text corpus between a document at version N to version N +1.

User 600 is an example of, or includes aspects of, the corresponding element described with reference to FIGS. 1, 4, and 8. Reinforcement learning model 630 is an example of, or includes aspects of, the corresponding element described with reference to FIGS. 4, 5, and 8.

### Learning

A method, apparatus, non-transitory computer readable medium, and system for text summarization are described. One or more embodiments of the method, apparatus, non-transitory computer readable medium, and system include generating a first summary of a corpus of information at a first time using a text summarization component, generating a second summary of the corpus of information at a second time using the text summarization component, wherein the corpus of information at the second time includes information related to an event, selecting one or more weights for a change summarization component, wherein the weights are selected based at least in part on a reinforcement learning model, generating a change summary for the first summary and the second summary using the change summarization component, receiving user interaction data based on the change summary, and training the reinforcement learning model based on the user interaction data.

Some examples of the method, apparatus, non-transitory computer readable medium, and system described above further include segmenting the user interaction data based on user-specific reading parameters, wherein the reinforcement learning model is trained based on the segmented user interaction data. Some examples of the method, apparatus, non-transitory computer readable medium, and system described above further include scoring the change summary based on the user interaction data.

Some examples of the method, apparatus, non-transitory computer readable medium, and system described above further include generating a training text summary using the text summarization component. Some examples further include comparing the training text summary to a ground truth text summary. Some examples further include training the text summarization component based on the comparison.

Some examples of the method, apparatus, non-transitory computer readable medium, and system described above further include generating a training change summary using the change summarization component. Some examples further include comparing the training change summary to a ground truth change summary. Some examples further include training the change summarization component based on the comparison.

FIG. 7 shows an example of a process for reinforcement learning according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 700, the system generates a first summary of a corpus of information at a first time using a text summarization component. The first summary may include only a single input text document. In some cases, the operations of this step refer to, or may be performed by, a text summarization component as described with reference to FIGS. 5, 6, and 8.

At operation 705, the system generates a second summary of the corpus of information at a second time using the text summarization component, where the corpus of information at the second time includes information related to an event. The second summary may be the result of a change to the original input text document or a new input text document that supersedes the original input text document. In some cases, the operations of this step refer to, or may be performed by, a text summarization component as described with reference to FIGS. 5, 6, and 8.

At operation 710, the system selects one or more weights for a change summarization component, where the weights are selected based on a reinforcement learning model. In some cases, the operations of this step refer to, or may be performed by, a reinforcement learning model as described with reference to FIGS. 4-6, and 8.

At operation 715, the system generates a change summary for the first summary and the second summary using the change summarization component. After an event is detected, the system generates a summarization of the changes of the newest document compared to the previous document. In some cases, the operations of this step refer to, or may be performed by, a change summarization component as described with reference to FIGS. 5, 6, and 8.

At operation 720, the system receives user interaction data based on the change summary. The user interaction data may refer to any interaction a user may have with the document, such as a change to the text. In some cases, the operations of this step refer to, or may be performed by, a user interface as described with reference to FIG. 5.

At operation 725, the system trains the reinforcement learning model based on the user interaction data. In some cases, the operations of this step refer to, or may be performed by, a reinforcement learning model as described with reference to FIGS. 4-6, and 8.

FIG. 8 shows an example of a reinforcement learning model diagram according to aspects of the present disclosure. The example shown includes user 800, change summarization network 805, interaction database 825, and reinforcement learning model 830.

Change summarization network 805 is an example of, or includes aspects of, the corresponding element described with reference to FIGS. 4-6. In one embodiment, change summarization network 805 includes text summarization component 810, scoring component 815, and change summarization component 820.

Text summarization component 810, scoring component 815, and change summarization component 820 are examples of, or includes aspects of, the corresponding element described with reference to FIGS. 5 and 6. User 800 is an example of, or includes aspects of, the corresponding element described with reference to FIGS. 1, 4, and 6.

Interaction database 825 is an example of, or includes aspects of, the corresponding element described with reference to FIG. 4. Reinforcement learning model 830 is an example of, or includes aspects of, the corresponding element described with reference to FIGS. 4-6.

In the example scenario of a reinforcement learning model of FIG. 8, a change summary is output from the change summarization network 805, as referenced in FIG. 6. User 800 provides interactions with the change summary, and the interactions are stored in the interaction database 825. The interactions are provided to the reinforcement learning model 830, which outputs learned text parameters back to the change summarization network 805. Therefore, the change summary is optimized based on user interactions.

The initial change summary is provided for N specific users, by taking into account input features pertaining to a user role, knowledge graph variations over time, presented content, and user feedback (i.e., implicit or explicit) to text summaries.

A final candidate change summary is selected and stored in database 825 (e.g., as DocX_time1 . . . N). An iterative loop (e.g., a for-loop) is run through final candidate change summaries and compared with a knowledge graph (KG) of users. As an example, for a document DocX_time2 . . . N, summary of DocX_time2 . . . N is compared against summary from DocX_time *, where time * is the previous version of DocX.

Advanced natural language processing (NLP) comparison techniques (e.g., Jaccard Similarity or comparing embeddings) create a similarity score for the change summary of a document (e.g., DocX_time2 . . . N) on comparison to a previous text and/or change summary. The similarity score or deviation from context is computed using cosine similarity:

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} \qquad ( 1 )$$

The text in a change (e.g., DocX_time2 . . .N) summary is scored with the scoring component 815. If the score falls below a pre-determined threshold (e.g., 49% similarity score or less), the text is labelled as new and text with a similarity score above the threshold is labelled as old.

The content labelled as new is re-run through the change summarization network 805 and a current summary (i.e., DocX_time1) or summary changes (i.e., DocX_time2 . . . N) are presented to users. User actions are observed, and feedback gathered on text summary satisfaction along role-based and event-based dimensions. User actions and feedback are stored in the database 825 (e.g., in user interaction history store).

The system predicts a summary and text to be used within sentences to provide a concise variant of the summary using a recurrent neural network architecture (e.g., long short-term memory, LSTM model).

A reward function is computed in the reinforcement learning model 830, as part of feedback learning. If the reward function is computed to be positive (i.e., +x) based on audio or textual feedback, the reinforcement learning model 830 moves to the next document of a user and a confidence factor is increased. In case of a negative reward function as part of feedback or reinforcement learning, input features are perturbed in a given state S (after y iterations from an initial sample that were provided based on proceeding in another version).

The changed learned text parameters (i.e., including the vocabulary) are compared using cosine similarity and word embedding after label encoding the categorical vectors into numerical features.

When a change summary is presented to a user, it may also be stored in a cloud repo along with the user's profile and user-specific models. Then, data perturbations may be performed as part of a contrastive explainability function. For example, a contrastive explainability module may provide information that identifies factors that determine the content of the change summary.

The pertinent positive (PP) and pertinent negative (PN) language and summary outputs pertaining to content features based on a profile are perturbed around the median of numerical vectors to give a sustainable tracked summary of changes and visible changes of highest interest are presented to a user to provide insights to tweak input features and content.

According to some embodiments, reinforcement learning model 830 selects one or more weights for a change summarization component, where the weights are selected based on a reinforcement learning model 830. In some examples, reinforcement learning model 830 trains the reinforcement learning model 830 based on the user interaction data. In some examples, reinforcement learning model 830 segments the user 800 interaction data based on user-specific reading parameters, where the reinforcement learning model 830 is trained based on the segmented user 800 interaction data.

In some examples, reinforcement learning model 830 receives a training text summary from the text summarization component. In some examples, reinforcement learning model 830 compares the training text summary to a ground truth text summary. In some examples, reinforcement learning model 830 trains the text summarization component based on the comparison. In some examples, reinforcement learning model 830 generates a training change summary using the change summarization component. In some examples, reinforcement learning model 830 compares the training change summary to a ground truth change summary. In some examples, reinforcement learning model 830 trains the change summarization component based on the comparison.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described systems and methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
generating a first summary of a corpus of information at a first time using a text summarization component;
generating a second summary of the corpus of information at a second time using the text summarization component, wherein the corpus of information at the second time includes information related to an event;
selecting one or more weights for a change summarization component, wherein the one or more weights are applied to an input of the change summarization component including user-specific reading parameters; and
generating a change summary for the first summary and the second summary using a change summarization network.

2. The method of claim 1, wherein the one or more weights are selected based on a reinforcement learning model.

3. The method of claim 1, wherein the user-specific reading parameters are input to the change summarization component.

4. The method of claim 1, wherein the user-specific reading parameters are input to a text summarizer.

5. The method of claim 1, further comprising:
identifying a role of a user, wherein text summarization reading parameters are determined based on the role of the user.

6. The method of claim 1, further comprising:
identifying one or more events including the event, wherein the one or more events are identified based on a role of a user.

7. The method of claim 1, further comprising:
generating a plurality of text summaries corresponding to the first time;
scoring the plurality of text summaries; and
selecting the first text summary based on the scoring.

8. The method of claim 1, further comprising:
generating an explanation summary for the change summary.

9. The method of claim 8, wherein the explanation summary indicates portions of the change summary that are based on a role of a user, portions of the change summary that are based on user feedback, portions of the change summary that are based on events that occurred, or some combination thereof

10. The method of claim 1, wherein the change summarization component is customized for a specific user based on user feedback.

11. An apparatus comprising:
a text summarization component configured to generate a first summary of a corpus of information at a first time and a second summary of the corpus of information at a second time, wherein the corpus of information at the second time includes information related to an event;
a change summarization component configured to generate a change summary for the first summary and the second summary based on the event;
a reinforcement learning model configured to update one or more weights of the text summarization component or the change summarization component.

12. The apparatus of claim 11, wherein the text summarization component comprises a sentence extraction model, a latent semantic analysis (LSA) model, or a Bayesian topic model.

13. The apparatus of claim 11, wherein the change summarization component comprises a recurrent neural network (RNN) or a transformer network.

14. The apparatus of claim 11, further comprising:
a user interface configured to display the change summary to a user and collect feedback from the user.

15. The apparatus of claim 11, wherein the one or more weights are applied to an input layer of the change summarization component.

16. A method of training a neural network comprising:
generating a first summary of a corpus of information at a first time using a text summarization component;
generating a second summary of the corpus of information at a second time using the text summarization component, wherein the corpus of information at the second time includes information related to an event;
selecting one or more weights for a change summarization component, wherein the weights are selected based at least in part on a reinforcement learning model;
generating a change summary for the first summary and the second summary using the change summarization component;
receiving user interaction data based on the change summary; and
training the reinforcement learning model based on the user interaction data.

17. The method of claim 16, further comprising:
segmenting the user interaction data based on user-specific reading parameters, wherein the reinforcement learning model is trained based on the segmented user interaction data.

18. The method of claim 16, further comprising:
scoring the change summary based on the user interaction data.

19. The method of claim 16, further comprising:
generating a training text summary using the text summarization component;
comparing the training text summary to a ground truth text summary; and
training the text summarization component based on the comparison.

20. The method of claim 16, further comprising:
generating a training change summary using the change summarization component;
comparing the training change summary to a ground truth change summary; and
training the change summarization component based on the comparison.
